(19) United States
(12) Patent Application Publication
(10) Pub. No.: US 2025/0029324 A1
(43) Pub. Date: Jan. 23, 2025

(54) IMAGE DRAWING METHOD AND APPARATUS, AND ELECTRONIC DEVICE AND STORAGE MEDIUM

(71) Applicant: Beijing Bytedance Network Technology Co., Ltd., Shijingshan District, Beijing (CN)

(72) Inventor: Guangwei WANG, Beijing (CN)

(21) Appl. No.: 18/712,188

(22) PCT Filed: Nov. 17, 2022
(86) PCT No.: PCT/CN2022/132486

§ 371 Date: May 21, 2024

(30) Foreign Application Priority Data
Nov. 22, 2021 (CN) 202111387440.3

(51) Int. Cl. G06T 15/50; G06T 7/40; G06T 7/70; G06T 15/04

(52) U.S. Cl. CPC G06T 15/506; G06T 7/40; G06T 7/70; G06T 15/04; G06T 2207/20081

(57) ABSTRACT

An image drawing method and an apparatus, and an electronic device and a storage medium. The method of drawing an image comprises: obtaining an image to be processed; wherein the image to be processed comprises a target coating of a material to be determined; determining target light source information and target editing parameter information corresponding to the image to be processed respectively; determining target material parameter information of the target coating according to the target light source information and a target normal map of the image to be processed; determining a target image based on the target material parameter information and the target editing parameter information.

The present application claims the priority of the Chinese patent application with the application number of 202111387440.3 and the filing date of Nov. 22, 2021, the content of which is hereby incorporated by reference in its entirety.

### FIELD

The present disclosure relates to the field of computer technology, for example, to a method and an apparatus of drawing an image, and an electronic device and a storage medium.

### BACKGROUND

Material acquisition is one of the more important technologies in current graphics research. Based on the material acquisition technology, a single image as input may be processed, and then the material parameters of the object in the image may be output.

However, there is a certain difference between the material parameters obtained at this time and the material parameters used by the actual object. As a result, when drawing an image based on the material parameters with the certain difference, the obtained image is quite different from the image actually required by the user, that is, the obtained images are fake, causing technical problems that result in poor user experience.

### SUMMARY

The present disclosure provides a method and an apparatus of drawing an image, and an electronic device and a storage medium, which not only realize accurate estimation of material parameters, but also obtain the best rendering effect.

In a first aspect, the present disclosure provides a method of drawing an image, the method comprising:
obtaining an image to be processed; wherein the image to be processed comprises a target coating of a material to be determined;
determining target light source information and target editing parameter information corresponding to the image to be processed respectively;
determining target material parameter information of the target coating according to the target light source information and a target normal map of the image to be processed;
determining a target image based on the target material parameter information and the target editing parameter information.

In a second aspect, the present disclosure further provides an apparatus for drawing an image, the apparatus comprising:
an image to be processed obtaining module, configured to obtain an image to be processed; wherein the image to be processed comprises a target coating of a material to be determined;
an information determining module, configured to determine target light source information and target editing parameter information corresponding to the image to be processed respectively;
an target material parameter information determining module, configured to determine target material parameter information of the target coating according to the target light source information and a target normal map of the image to be processed;
an target image determining module, configured to determine a target image based on the target material parameter information and the target editing parameter information.

In a third aspect, the embodiments of the present disclosure further provide an electronic device, the electronic device comprising:
at least one processor;
a store configured to store at least one program;
the at least one program, when executed by the at least one processor, causes the at least one processor implements the above method of drawing an image.

In a fourth aspect, the embodiments of the present disclosure further provide a storage medium containing computer-executable instructions, the computer-executable instructions, when executed by a computer processor, being used for performing the above method of drawing an image.

### BRIEF DESCRIPTION OF THE DRAWINGS

FIG. 1 is a schematic flowchart of a method of drawing an image provided by Embodiment 1 of the present disclosure;

FIG. 2 is a schematic flowchart of a method of drawing an image provided in Embodiment 2 of the present disclosure;

FIG. 3 is a network structure diagram of a method of drawing an image provided in Embodiment 2 of the present disclosure;

FIG. 4 is a schematic flowchart of a method of drawing an image provided by Embodiment 3 of the present disclosure;

FIG. 5 is a structural block diagram of an apparatus of drawing an image provided in Embodiment 4 of the present disclosure;

FIG. 6 is a schematic structural diagram of an electronic device provided by Embodiment 5 of the present disclosure.

### DETAILED DESCRIPTION OF EMBODIMENTS

Embodiments of the present disclosure will be described below with reference to the accompanying drawings. Although some embodiments of the present disclosure are shown in the drawings, the present disclosure may be embodied in various forms, and these embodiments are provided for understanding of the present disclosure. The drawings and embodiments of the present disclosure are for exemplary purposes only.

Multiple steps described in the method implementations of the present disclosure may be executed in different orders, and/or executed in parallel. Additionally, method embodiments may include additional steps and/or omit performing illustrated steps. The scope of the present disclosure is not limited in this regard.

As used herein, the term “comprise” and its variations are open-ended, i.e., “including but not limited to”. The term “based on” is “based at least in part on”. The term “one embodiment” means “at least one embodiment”; the term “another embodiment” means “at least one further embodiment”; the term “some embodiments” means “at least some embodiments.” Relevant definitions of other terms will be given in the description below.

Concepts such as “first” and “second” mentioned in this disclosure are only used to distinguish different devices, modules or units, and are not used to limit the sequence or interdependence of the functions performed by these devices, modules or units relation.

The modifications of “one” and “plurality” mentioned in the present disclosure are illustrative but not restrictive, and those skilled in the art should understand that unless the context indicates otherwise, it should be understood as “one or more”.

Before introducing the technical solution, an example description may be given to the application scenario. This technical solution may be applied to any situation where the material needs to be determined. For example, in a live broadcast scene or an art scene, it is necessary to determine whether the user is suitable for applying a lipstick, and the lipstick may be used as the paint of the material to be determined. The paint may be coated on the silica gel ball, and its image is taken based on a photographing apparatus, and the obtained image includes the paint of the material to be determined. At this time, the material information of the paint may be determined based on the technical solution, and then a corresponding image may be drawn based on the material information.

### Embodiment One

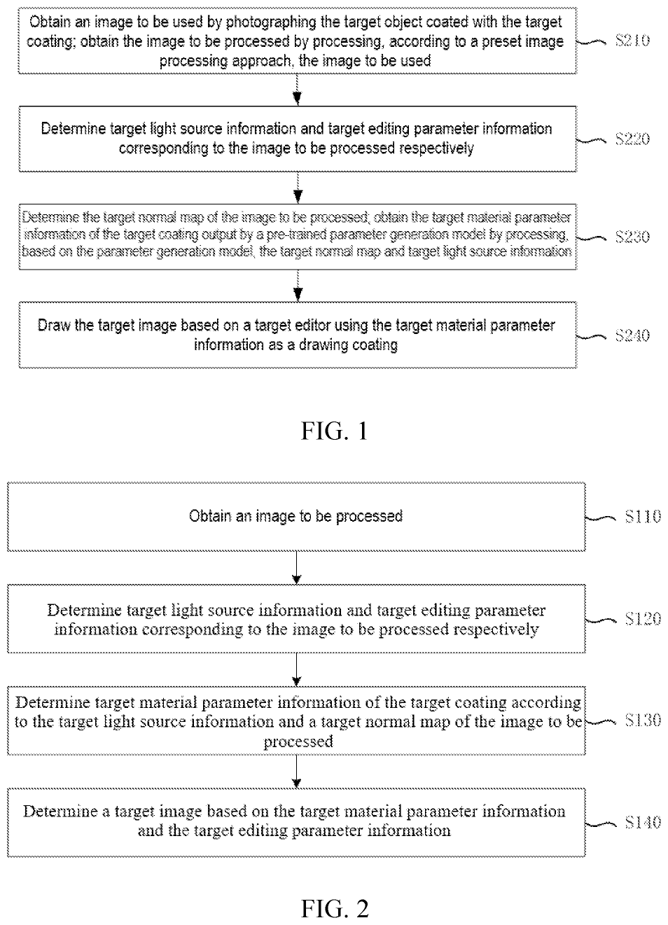

FIG. 1 is a schematic flowchart of a method of drawing an image provided by Embodiment 1 of the present disclosure. This embodiment is applicable to situations where the server needs to draw a corresponding image based on material information, and the method may be executed by an apparatus of drawing an image, the apparatus may be realized in the form of software and/or hardware, and the hardware may be an electronic device, such as a mobile terminal, a personal computer (PC) terminal or a server, etc.

As shown in FIG. 1, the method of the present embodiment comprises:

S110. Obtaining an image to be processed.

The image to be processed includes the target coating of a material to be determined. In the rendering simulation process of the 3D model, the material to be determined is the material whose visual attributes need to be determined. There are many visual attributes of the material to be determined, such as color, texture, smoothness, transparency, reflectivity, and refractive index and luminosity; correspondingly, the target coating is a substance coated on the surface of the object in the image to reflect the material to be determined, and may be a carrier of the material to be determined.

Since the geometric shape of the object and the lighting conditions of the environment will affect the performance of the object on the image, in order to accurately collect the parameter information of the material to be determined in the subsequent process, the object in the image to be processed should have a concave-convex surface to coat the target coating. At the same time, at least a light source is required to illuminate the target coating coated on the surface of the object.

In this embodiment, there are multiple ways to obtain images to be processed, and there may be one or more images to be processed. For example, a specific image may be retrieved from a store storing multiple images as an image to be processed according to preset rules, and a camera may also be used to photograph an object coated with the target coating to obtain a real-time image to be processed. The manner of obtaining the image to be processed should be selected according to the actual situation, which is not limited in this embodiment of the present disclosure.

S120. Determining target light source information and target editing parameter information corresponding to the image to be processed respectively.

In this embodiment, when the light source is illuminated on the object coated with the target coating, it may produce a lighting effect, and the information corresponding to this lighting effect is the target light source information, and the target light source information may reflect the attributes of lighting from multiple dimensions, such as lighting color, lighting intensity, lighting direction, etc. In the image to be processed, there may be one or more light sources for illuminating the target coating. When there is one light source, a lighting effect will be produced when the light illuminating on the target coating on the surface of the object. The information corresponding to this lighting effect is the target light source information. When there are multiple light sources, multiple rays of light will be continuously superimposed when they illuminate the target coating on the surface of the object, and the final lighting effect will be obtained. The information corresponding to the final lighting effect is the target light source information.

In this embodiment, the target editing parameter information refers to the parameters used in the image rendering program to determine the rendering approaches of objects and materials. The image rendering program may be a shader, which is an editable program for image rendering used to replace the fixed rendering pipeline, and may use environmental information (such as lighting, reflection probes, ambient light) as input, and output the pixels that make up the object on the screen. The shader consists of three parts: a shader name, parameters and sub-shaders. Exemplarily, it may comprise a vertex shader responsible for calculations such as geometric relations of vertices, and a pixel shader responsible for calculations such as chip source colors. It may also comprise optional input effect parameters that determine the display in the material bar, such as textures, colors, cube textures, highlights, diffuse reflections, transparency, etc. In this embodiment, all the above-mentioned editable parameters in the shader may be used as the target editable parameter information.

In this embodiment, different editing parameter information may represent different rendering approaches. Therefore, the process of determining the target editing parameter information is actually a process of determining the rendering approach for the material to be determined in the image to be processed.

In the actual application process, the algorithm based on deep learning may be used to determine the target light source information in the image to be processed. At the same time, for images to be processed of different types or carrying different tags, a mapping table representing the correspondence between these types/tags and the target editing parameter information may be pre-stored. After obtaining the image to be processed, the corresponding target editing parameter information may be determined by looking up the table. Exemplarily, when the tag carried by the obtained image to be processed is A, the pre-set parameter information corresponding to the tag A may be determined as the target editing parameter information by means of table lookup.

S130. Determining target material parameter information of the target coating according to the target light source information and a target normal map of the image to be processed.

In this embodiment, since an object with a concave-convex surface is selected to coat the target coating in the image to be processed, a target normal map corresponding to the object in the image to be processed may be generated. Wherein, the normal map may be a normal bump, that is, a normal line is made on each point of the concave-convex surface of the original object, and the direction of the normal line is marked by the red-green-blue color channel, that is, a different surface parallel to the original bumpy surface. In the process of actual application, the surface with low detail level may show the precise lighting direction and reflection effect of high detail level by determining the normal map. For example, after the normal bump is baked out of the model with high detail level, even if it is pasted on the normal bump channel of the low-end model, it can make the surface have the rendering effect of light and shadow distribution. At the same time, the use of normal bumps reduces the number of faces and calculation content required in the rendering process of the object, and optimizes the rendering effect.

After obtaining the target normal map of the image to be processed, it may be processed in combination with the target light source information, and the target normal map and the target light source information may be input into the deep learning algorithm based model to obtain the output result. In this embodiment, the output of the model is the target material parameter information corresponding to the material to be determined on the target coating, such as the color, texture, smoothness, transparency, reflectivity, refractive index and luminosity of the material. When the computer renders this material, the target material parameter information is the data basis in the image processing process.

After obtaining the target material parameter information of the material to be determined according to the target light source information and the target normal map, the information may be stored in a specific store, so that it may be called in the subsequent image processing process, avoiding the waste of computing resources caused by determining material parameter information multiple times.

S140. Determining a target image based on the target material parameter information and the target editing parameter information.

In this embodiment, after determining the target material parameter information of the material to be determined in the image to be processed and the target editing parameter information (rendering approach) corresponding to the material, the rendering simulation operation may be performed. Based on the specific rendering approach and the target material parameter information in the shader, the material to be processed may be rendered and simulated on the surface of the three-dimensional object model, and the obtained rendering result may be used as the target image.

Exemplarily, the object in the image to be processed is coated with a lipstick as the material to be determined, and the color, texture, smoothness and other information of the lipstick are determined as the target material parameter information, and at the same time, a best rendering approach for the lipstick in the shader may be determined, and the editable parameters corresponding to this rendering approach in the shader may be used as the target editing parameter information. Based on the above information, the computer may render the lipstick on the surface of a specific three-dimensional object in a rendering approach that best suits the material of the lipstick, and then use the obtained rendering result as the target image.

According to the technical solution of the embodiment of the present disclosure, the image to be processed including the target coating whose material is to be determined is obtained first, and the target light source information and the target editing parameter information corresponding to the image to be processed are respectively determined. The target normal map is used to determine the target material parameter information of the target coating. Finally, the target image is determined based on the target material parameter information and the target editing parameter information, which not only realizes accurate estimation of material parameters, but also determines the rendering approach that best matches the material. Then when rendering according to the material parameters based on the best rendering approach, the target image obtained is closest to the theoretical image, so that the image the user appreciates is closest to the actual image, thereby improving the technical effect of the user experience.

### Embodiment Two

FIG. 2 is a schematic flowchart of a method of drawing an image provided by Embodiment 2 of the present disclosure. On the basis of the foregoing embodiments, the target object is photographed based on the photographing apparatus, and the image to be used is processed according to the preset image processing approach, so that the image to be processed meets the requirements of the model; the illumination estimation model and the editor selection model are used to process the image to be processed respectively, and the target light source information and the target editing parameter information are obtained in a differentiated manner, which is convenient for determining the target material parameter information of the target coating when subsequently drawing the image. Taking the target material parameter information as parameters and drawing the target image based on the target editor, the rendering simulation of the material to be determined is realized. For its implementation, please refer to the technical solution of this embodiment. Among them, technical terms that are the same as or corresponding to the above embodiments will not be described again here.

As shown in FIG. 2, the method comprises the following steps:

S210. obtaining an image to be used by photographing the target object coated with the target coating; obtaining the image to be processed by processing the image to be used according to a preset image processing approach.

In this embodiment, in order to obtain the image to be processed, the photographing apparatus may first be used to photograph the target object coated with the target coating. Exemplarily, in a case that the target coating is a lipstick, a white silica gel ball may be selected as an object with a concave-convex surface, and the target object may be obtained after the lipstick is coated on the silica gel ball. At the same time, use the flash as a light source and make it illuminating at least on the lipstick-coated part of the silicone ball. Based on this, after the silica gel ball is photographed by the photographing apparatus, the obtained image is the image to be used.

In order to obtain the normal map corresponding to the image to be processed, it is necessary to apply the target coating on an object with a concave-convex surface (e.g., a spherical object), coat the target paint on the white silica gel ball, and use the photographing apparatus to photograph the white silica gel ball to obtain the image to be used.

In this embodiment, in order to make the input image more conform to the requirements of the model, the image to be used needs to be processed to obtain the image to be processed. For example, the image to be used is cropped so that the target object is presented in the image to be processed at a preset ratio, and the image to be processed may be filled with the target object by clipping the image to be used.

In the actual application process, “making a target object edge displayed in the image to be processed tangent to an edge line of the image to be processed” may be used as the goal, and the image to be used may be clipped. When the target coating is coated on the white silicone ball, in the cropped image to be processed, the edge line of the image is tangent to the edge of the white silicone ball.

In the actual application process, the image to be used may be processed according to the preset image processing approach. For example, in a case that the target object is the silicone ball in the above example, the preset image processing approach is: use straight lines as cutting lines to cut off areas on the four sides of the image that are not related to the target object to obtain the image to be processed. In the image to be processed obtained after processing, the displayed target object is tangent to the edge line of the image to be processed.

S220. Determining target light source information and target editing parameter information corresponding to the image to be processed respectively.

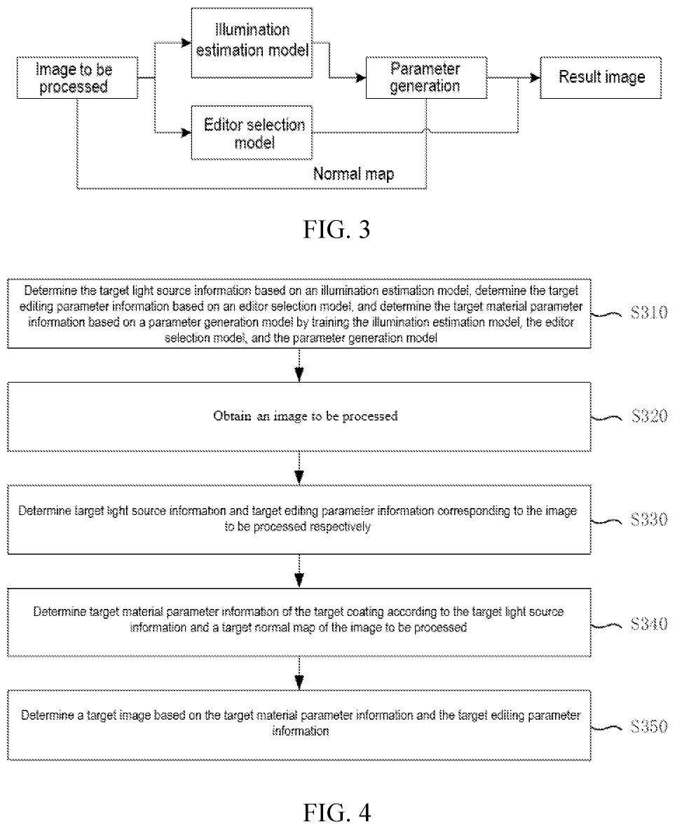

Determining the target light source information corresponding to the image to be processed by processing the image to be processed based on an illumination estimation model obtained by pre-training. This process will be described below with reference to FIG. 3.

Referring to FIG. 3, in this embodiment, the illumination estimation model may be a pre-trained deep learning based model, at least used to determine the target light source information, after the illumination estimation model is integrated into the corresponding module, its network structure is residual network (ResNet), the residual network belongs to a convolutional neural network, this network structure is characterized by easy optimization, and may increase the accuracy by increasing the depth, its internal residual block uses a jump connection, and the gradient disappearance problem caused by increasing the depth in the deep neural network is alleviated. In this embodiment, the image to be processed is used as the input of the illumination estimation model, and the target light source information corresponding to the image may be output after the illumination estimation model processes it. This process will be described below.

Obtaining pixel coordinate information of a highlight point in the image to be processed output by the illumination estimation model by inputting the image to be processed into the illumination estimation model; determining, based on the pixel coordinate information, the target light source information of a light source upon obtaining the image to be processed by photographing.

In this embodiment, the target object is illuminated by the light source during the photographing process, therefore, the finally determined target light source information at least comprises the illumination angle at which the light source illuminates the target object. Continuing to take the above-mentioned silica gel ball as an example, a plane Cartesian coordinate system is pre-constructed based on the image to be processed, and the coordinates of the silica gel ball in the coordinate system (i.e., the two-dimensional (2D) position information of the silica gel ball) are determined. After the image is input to the illumination estimation model, the model will output the coordinate value of the brightest point on the silicone ball (i.e., the highlight point where the object directly reflects the light source) on the coordinate system. Since the position of the silicone ball in the coordinate system is known, based on the two sets of coordinate values, the illumination angle of the flashlight relative to the silicone ball when the photographing apparatus photographs the silicone ball may be calculated. During the photographing process, even if there are multiple light sources, the light generated by these light sources will be continuously superimposed when they are illuminated on the target object. Therefore, there is only one highlight point and the corresponding target light source information.

Obtaining the target editing parameter information corresponding to the image to be processed by processing the image to be processed based on an editor selection model obtained by pre-training.

The editor selection model may also be a pre-trained deep learning based model, at least used to determine the parameter information of the shader, that is, to determine the rendering approach corresponding to the material to be determined. Similar to the illumination estimation model, after the editor selection model is integrated into the corresponding module, its corresponding network structure is also a residual network. The embodiments of the present disclosure will not go into details here, and the following describes the process of determining the target editing parameter information.

Obtaining an attribute value output by the editor selection model corresponding to each editing parameter to be selected by inputting the image to be processed into the editor selection model, and determining the target editing parameter information from a plurality of editing parameters to be selected based on each attribute value.

Referring to FIG. 3, in this embodiment, since the subsequent rendering process needs to use the shader, and different parameter information in the shader directly determines the rendering simulation effect of the material, therefore, the editor selection model may at least obtain a part of the parameters required by the rendering of the material (e.g., the probability of each parameter corresponding to the material to be determined), and then filter out the target parameter information based on these parameters. Continue to take the above silicone ball as an example. After inputting the image of the silicone ball coated with the lipstick into the editor selection model, the model may output the probability corresponding to each parameter of the shader. For example, the probability of selecting the map A and the color a, and the probability of selecting the map B and the color b. After comparing the two obtained probability values, select the parameter of the shader corresponding to the highest probability as the target editing parameter information.

In this embodiment, the illumination estimation model and the editor selection model are used to process the image to be processed separately, and the target light source information and the target editing parameter information are obtained in a differentiated manner, which facilitates the subsequent drawing of the image and the determination of the target material parameter information of the target coating.

S230. determining the target normal map of the image to be processed; and obtaining the target material parameter information of the target coating output by a parameter generation model obtained by pre-training by processing the target normal map and the target light source information based on the parameter generation model.

The parameter generation model is pre-trained, and after it is integrated into the corresponding module, its network structure may be set in a customized way. For the parameter generation model, its input is the target normal map and the target light source information, and its output is various types of variables as target material parameter information, including reflection function parameters, and the output may be bidirectional reflectance distribution function (BRDF) parameter, BRDF is used to define how the irradiance in a given incident direction affects the radiance in a given outgoing direction, it describes how the incident light is distributed in multiple outgoing directions after being reflected by a surface, and it may be a variety of reflections from ideal specular reflection to diffuse reflection, isotropic or anisotropic. Therefore, the BRDF parameters can accurately reflect various parameter information of the target material, such as the specific values of the material color, the metallicity and the roughness.

When the parameter generation model is integrated into the module, the parameter generation module may also select the corresponding network module according to the different output results of the model (i.e., different shaders) selected by the editor, so that the network calculation and the shader calculation are consistent, causing the final rendering simulation result is closest to the real performance of the target material.

S240. Drawing the target image based on a target editor using the target material parameter information as a parameter.

In this embodiment, after the target editing parameter information is determined, the corresponding target editor may be determined. A mapping table representing the corresponding relationship between the multiple target editing parameter information and the multiple editors may be pre-stored in the shader. After the target editing parameter information is determined, the corresponding target editor may be obtained by looking up the table. The target editor matches the target editing parameter information, at least for performing rendering simulation operations for the target material.

In this embodiment, since the target material parameter information may be used as a reflection of the target coating in terms of parameter values. Therefore, after determining the target editor used for rendering simulation of the target material, the target coating may be drawn based on the target material parameter information to obtain the target image, wherein in the obtained target image, any object may be coated with the target coating. Exemplarily, a specific shader language (e.g., High Level Shader Language (HLSL), OpenGL Shading Language (GLSL), Render Monkey (RM) language, etc.) may be used to assign values in the target material parameter information to the target editing parameters in the target editor, and then the rendering simulation operations are performed based on application programming interfaces such as Open Graphics Library (OpenGL), and finally a new 3D object model is coated the target coating, and generate its corresponding image.

In the technical solution of this embodiment, the target object is photographed based on the photographing apparatus, and the image to be used is processed according to the preset image processing approach, so that the image to be processed meets the requirements of the model; the image to be processed is processed by using the illumination estimation model and the editor selection model separately, and the target light source information and the target editing parameter information are obtained in a differentiated manner, so as to facilitate the determination of the target material parameter information of the target coating while drawing the image subsequently; taking the target material parameter information as parameters and drawing the target image based on the target editor, the rendering simulation of the material to be determined is realized.

### Embodiment Three

FIG. 4 is a schematic flowchart of a method of drawing an image provided by Embodiment 3 of the present disclosure. On the basis of the foregoing embodiments, obtaining a plurality of images to be trained, and based on these images, the illumination estimation model to be trained, the editor selection model to be trained, and the parameter generation model to be trained are trained, so that after the model training is completed, the target material parameter information corresponding to the image to be processed is obtained based on these models, and the target editor is used to perform rendering simulation on the target coating. For its implementation, refer to the technical solution of this embodiment. Wherein, technical terms that are the same as or corresponding to those in the foregoing embodiments will not be repeated here.

The illumination estimation model, editor selection model, and parameter generation model obtained through training may also be implemented in combination with the structure shown in FIG. 3. At this point, it is necessary to replace the image to be processed with the image to be trained. At the same time, after obtaining the result image corresponding to the image to be trained, the loss may be calculated with the image to be trained, so as to adjust the model parameters in the model based on the loss value.

As shown in FIG. 4, the method includes the following steps:

S310. Obtain the illumination estimation model, the editor selection model, and the parameter generation model through training, so as to determine the target light source information based on the illumination estimation model, determine the target editing parameter information based on the editor selection model, and determine the target material parameter information based on the parameter generation model.

In this embodiment, in order to perform a rendering simulation operation on the material to be determined in the target coating, it is necessary to obtain the illumination estimation model, the editor selection model, and the parameter generation model through pre-training. For the above three models, the process of obtaining training results comprises steps such as building a training set, model training, and model parameter adjustment. These steps are described below.

Obtaining a plurality of images to be trained; for each image to be trained, obtaining actual light source information of the image to be trained output by the illumination estimation model to be trained by inputting a current image to be trained into the illumination estimation model to be trained; and determining an editing parameter to be used from a plurality of editing parameters to be selected by inputting the current image to be trained into the editor selection model to be trained.

There are multiple images to be trained, and the objects in each image are coated with the coating to be trained. The set constructed based on the images to be trained is the training set of the model. For each image to be trained, it may be used as input, processed by the illumination estimation model to be trained and the editor selection model to be trained, and the corresponding actual light source information and the editing parameters to be used are obtained, the actual light source information is the output result of the illumination model to be trained, the editing parameter to be used is the output result of the editor selection model to be trained. Before the training of the model is completed, the actual light source information and the editing parameters to be used may not faithfully reflect the light source information and material parameter information of the environment where the target coating is located.

Exemplarily, when the above-mentioned models to be trained are all deep learning networks, 500 images to be trained may be selected to construct a training set, and the images in the set may be distributed and input to the above-mentioned two models to be trained, and these images are processed by the model to obtain the actual light source information of the 500 images and the corresponding editing parameters to be used respectively.

Obtaining actual material parameter information of the coating to be trained corresponding to the current image to be trained output by the parameter generation model to be trained by using the actual light source information and the normal map of the current image to be trained as an input of the parameter generation model to be trained, and drawing an image to be compared based on the actual material parameter information.

Continuing to illustrate with the above example, for the 500 images to be trained in the training set, each image may be analyzed and the corresponding normal map may be obtained, and each normal map may be combined with the corresponding actual light source information to construct the training set for the parameter generation model to be trained, the training set comprises 500 groups of inputs corresponding to the images to be trained. After the training parameter generation model processes the input, it may output the actual material parameter information for the target coating in each image. Similar to the actual light source information and the editing parameters to be used, the actual material parameter information output by the model before training is completed may not faithfully reflect the material of the target coating. Finally, based on the actual material parameter information and using the corresponding editor, the target coating in the 500 images may be rendered and simulated to obtain the corresponding images to be compared.

Correcting parameters in the illumination estimation model to be trained, the editor selection model to be trained and the parameter generation model to be trained based on theoretical light source information, a theoretical editing parameter, the image to be compared, the actual light source information, the editing parameter to be used corresponding to the current image to be trained and the current image to be trained; and obtaining the illumination estimation model, the editor selection model, and the parameter generation model by taking convergences of loss functions in the illumination estimation model to be trained, the editor selection model to be trained, and the parameter generation model to be trained as training targets.

In this embodiment, for the 500 images to be trained in the training set, each image to be trained may be used as an input of the model to be trained. Wherein, each image to be trained also comprises predetermined theoretical light source information and theoretical editing parameters, wherein the theoretical light source information is the actual illumination angle of the target object illuminated by the light source in the image to be trained, and the theoretical editing parameters are the parameters corresponding to the target coating that may be accurately rendered by the editor. For each image to be trained, the current image to be trained may be input into the illumination estimation model to be trained and the editor selection model to be trained to obtain the actual light source information corresponding to the current image to be trained and the parameter information of the editor to be used. Input the actual light source information and the normal map of the current image to be trained into the parameter generation model to be trained to obtain the actual material parameters. According to the actual light source information and the theoretical light source information of the current sample to be trained, the model parameters in the illumination estimation model to be trained are corrected, and at the same time, the model parameters in the editor selection model to be trained are corrected based on the editing parameter information to be used and the theoretical editing parameter information. Correspondingly, the corresponding actual image may be drawn according to the actual material parameter information, and the model parameters in the parameter generation model to be trained may be corrected according to the actual image and the current image to be trained. In the process of correcting the model parameters, if it is detected that the loss functions of all the models to be trained are converged, the model training is considered to be completed, otherwise, the model parameters in the model to be trained will continue to be corrected based on the training samples.

The process of model parameter correction is described below.

Determine the actual distance difference according to the theoretical light source information and the actual light source information of the current image to be trained, so as to correct the model parameters in the illumination estimation model to be trained according to the actual distance difference; or, according to the actual light source information of the current image to be trained and the actual material parameter information, determine the first image, and correct the model parameters in the illumination estimation model to be trained according to the first image and the current image to be trained; correct the model parameters in the editor selection model to be trained according to the theoretical editing parameters and the editing parameters to be used corresponding to the current image to be trained; correct the model parameters in the parameter generation model to be trained according to the image to be compared and the current image to be trained.

Continuing to illustrate with the above example, after determining the theoretical light source information of each image to be trained and obtaining the actual light source information corresponding to these images, the difference between the two may be determined to determine the actual distance difference of the light source (e.g., the difference between the illumination position obtained by the illumination estimation model to be trained and the actual illumination position when the image is photographed), based on the actual distance difference, the model parameters in the illumination estimation model to be trained may be corrected. Similarly, when correcting the parameters in the editor selection model to be trained, the difference between the editing parameters to be used and the theoretical editing parameters of each image may be determined (e.g., the difference between the result weight output by the editor selection model to be trained and the real shader that the image should use), and correct the model parameters based on these differences; for the parameter generation model to be trained, the image to be compared as the network rendering result may be used to make a difference with the image in the training set itself, and the model parameters are corrected based on these differences. The parameter correction process of the above model is the process of continuously changing the parameter values selected in the model to make the calculated value close to the observed value. In this process, use the obtained measurement data and the output results of the model to be trained to perform back-reduction to obtain the parameters required to make the model faithfully reproduce the target coating.

For any of the above three models, 1000 images may also be randomly selected, based on 500 of which, the verification set of the model may be constructed to estimate the model parameters, and the remaining 500 images may be used as the test set to evaluate the model. After using the verification set to find the optimal model parameters, the 500 images in the training set and the 500 images in the verification set are mixed to form a new training set to optimize the model multiple times. When the measured target detection evaluation index of the model reaches the preset threshold, or the loss function converges, the model training is considered completed. At this point, after inputting an image to be processed into the above three models, the parameter generation model that has been trained may output the target material parameter information of the material to be determined, and use the corresponding editor to perform rendering simulation on the target coating.

The images in the training set, verification set, and test set in this embodiment may be simulated images or real collected images, which is not limited in this embodiment of the present disclosure. By using simulated data and real data to train the model together, the training effect of the model is improved.

S320. Obtaining the image to be processed.

S330. Determining target light source information and target editing parameter information corresponding to the image to be processed respectively.

S340. Determining target material parameter information of the target coating according to the target light source information and a target normal map of the image to be processed.

S350. Determining a target image based on the target material parameter information and the target editing parameter information.

In the technical solution of this embodiment, multiple images to be trained are obtained, and based on these images, the illumination estimation model to be trained, the editor selection model to be trained, and the parameter generation model to be trained are trained, so that after the model training is completed, based on these models, the target material parameter information corresponding to the image to be processed is obtained, and the target editor is used to render and simulate the target coating, so that the drawn image has the most realistic effect with the actual image.

### Embodiment Four

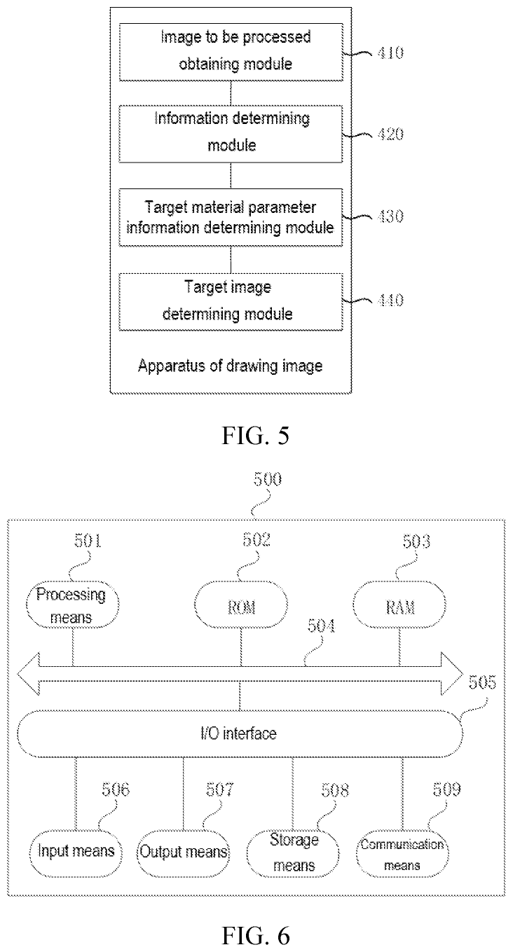

FIG. 5 is a structural block diagram of an apparatus of drawing an image provided in Embodiment 4 of the present disclosure, which may perform the method of drawing an image provided in any embodiment of the present disclosure, and has corresponding functional modules and effects for performing the method. As shown in FIG. 5, the apparatus comprises: an image to be processed obtaining module 410, an information determining module 420, a target material parameter information determining module 430 and a target image determining module 440.

The image to be processed obtaining module 410 is configured to obtain an image to be processed; wherein the image to be processed comprises a target coating of a material to be determined.

The information determining module 420 is configured to determine target light source information and target editing parameter information corresponding to the image to be processed respectively.

The target material parameter information determining module 430 is configured to determine target material parameter information of the target coating according to the target light source information and a target normal map of the image to be processed.

The target image determining module 440 is configured to determine a target image based on the target material parameter information and the target editing parameter information.

On the basis of the above technical solution, the image to be processed obtaining module 410 comprises an image to be used obtaining unit and an image to be processed determining unit.

The image to be used obtaining unit is configured to obtain an image to be used by photographing the target object coated with the target coating.

The image to be processed determining unit is configured to obtain the image to be processed by processing the image to be used according to a preset image processing approach; wherein the target object is presented in the image to be processed at a preset ratio, the image to be processed is filled with the target object, and a target object edge displayed in the image to be processed is tangent to an edge line of the image to be processed.

On the basis of the above technical solution, the information determining module 420 comprises a target light source information determining unit and a target editing parameter information determining unit.

The target light source information determining unit is configured to determine the target light source information corresponding to the image to be processed by processing the image to be processed based on an illumination estimation model obtained by pre-training.

The target editing parameter information determining unit is configured to obtain the target editing parameter information corresponding to the image to be processed by processing the image to be processed based on an editor selection model obtained by pre-training.

In an embodiment, the target light source information determining unit is configured to obtain pixel coordinate information of a highlight point in the image to be processed output by the illumination estimation model by inputting the image to be processed into the illumination estimation model; determine, based on the pixel coordinate information, the target light source information of a light source upon obtaining the image to be processed by photographing; wherein the target light source information comprises an illumination angle at which the light source illuminates the target object.

In one embodiment, the target editing parameter information determining unit is configured to input the image to be processed into the editor selection model, and obtain the attributes corresponding to each editing parameter to be selected output by the editor selection model value; determine target editing parameter information from multiple editing parameters to be selected based on each attribute value.

On the basis of the above technical solution, the target material parameter information determining module 430 comprises a target normal map determining unit and a target material parameter information determining unit.

The target normal map determining unit is configured to determine the target normal map of the image to be processed.

The target material parameter information determining unit is configured to obtain the target material parameter information of the target coating output by a parameter generation model obtained by pre-training by processing the target normal map and the target light source information based on the parameter generation model.

On the basis of the above technical solution, the target material parameter information comprises reflection function parameters, and the reflection function parameters at least comprises bidirectional reflection distribution function, metallicity and/or roughness.

In an embodiment, the target image determining module 440 is configured to draw the target image based on a target editor using the target material parameter information as a parameter; wherein the target editor matches the target editing parameter information.

On the basis of the above technical solution, the apparatus of drawing an image further comprises a model training module.

The model training module is configured to determine the target light source information based on an illumination estimation model, determine the target editing parameter information based on an editor selection model, and determine the target material parameter information based on a parameter generation model by training the illumination estimation model, the editor selection model, and the parameter generation model.

On the basis of the above technical solution, the model training module comprises an image to be trained obtaining unit, an actual light source information determining unit, an editing parameter to be used determining unit, an image to be compared drawing unit, a model parameter correcting unit and a model generating unit.

The image to be trained obtaining unit is configured to obtain a plurality of images to be trained; wherein the images to be trained is coated with a coating to be trained.

The actual light source information determining unit is configured to for each image to be trained, obtain actual light source information of the image to be trained output by the illumination estimation model to be trained by inputting a current image to be trained into the illumination estimation model to be trained.

The editing parameter to be used determining unit is configured to determine an editing parameter to be used from a plurality of editing parameters to be selected by inputting the current image to be trained into the editor selection model to be trained.

The image to be compared drawing unit is configured to obtain actual material parameter information of the coating to be trained corresponding to the current image to be trained output by the parameter generation model to be trained by using the actual light source information and the normal map of the current image to be trained as an input of the parameter generation model to be trained, and draw an image to be compared based on the actual material parameter information.

The model parameter correcting unit is configured to correct parameters in the illumination estimation model to be trained, the editor selection model to be trained and the parameter generation model to be trained based on theoretical light source information, a theoretical editing parameter, the image to be compared, the actual light source information, the editing parameter to be used corresponding to the current image to be trained and the current image to be trained.

A model generating unit configured to obtain the illumination estimation model, the editor selection model, and the parameter generation model by taking convergences of loss functions in the illumination estimation model to be trained, the editor selection model to be trained, and the parameter generation model to be trained as training targets.

In one embodiment, the model parameter correcting unit is configured to correct model parameters in the illumination estimation model to be trained according to an actual distance difference by determining the actual distance difference according to the theoretical light source information and the actual light source information of the current image to be trained; or, determine a first image according to the actual light source information and the actual material parameter information of the current image to be trained, and correct the model parameters in the illumination estimation model to be trained according to the first image and the current image to be trained; correct model parameters in the editor selection model to be trained according to the theoretical editing parameters and the editing parameters to be used corresponding to the current image to be trained; and correct model parameters in the parameter generation model to be trained according to the image to be compared and the current image to be trained.

According to the technical solution of the embodiment of the present disclosure, the image to be processed including the target coating whose material is to be determined is obtained first, and the target light source information and target editing parameter information corresponding to the image to be processed are respectively determined; according to the target light source information and the target normal map of the image to be processed, the target material parameter information of the target coating is determined; finally, the target image is determined based on the target material parameter information and target editing parameter information, which not only realizes accurate estimation of material parameters, but also determines the most suitable rendering approach of the material, and then based on the best rendering approach when rendering and drawing according to the material parameters, the target image obtained is closest to the theoretical image, so that the image appreciated by the user is closest to the actual image, thereby the technology effect of the user experience can be improved.

The apparatus of drawing an image provided in the embodiments of the present disclosure may perform the method of drawing an image provided in any embodiment of the present disclosure, and has corresponding functional modules and effects for performing the method.

The multiple units and modules included in the above-mentioned device are only divided according to functional logic, but are not limited to the above-mentioned division, as long as the corresponding functions may be realized; in addition, the names of multiple functional units are only for the convenience of distinguishing each other, and are not intended to limit the protection scope of the embodiments of the present disclosure.

### Embodiment Five

FIG. 6 is a schematic structural diagram of an electronic device provided by Embodiment 5 of the present disclosure. Referring now to FIG. 6, it shows a schematic structural diagram of an electronic device (such as the terminal device or server in FIG. 6) 500 suitable for implementing the embodiments of the present disclosure. The terminal device in the embodiments of the present disclosure may include but not limited to mobile phones, laptops, digital broadcast receivers, personal digital assistants (PDA), portable android device (PAD), portable multimedia players (PMP), vehicle-mounted terminals (such as vehicle-mounted navigation terminals), etc., and fixed terminals such as digital televisions (TV), desktop computers, etc. The electronic device 500 shown in FIG. 6 is only an example, and should not limit the functions and scope of use of the embodiments of the present disclosure.

As shown in FIG. 6, the electronic device 500 may comprises a processing means (such as a central processing unit, a graphics processing unit, etc.) that may perform a variety of appropriate actions and processes based on a program stored in a read-only memory (ROM) 502 or loaded from a storage means 508 into a random access memory (RAM) 503. In the RAM 503, various programs and data necessary for the operation of the electronic device 500 are also stored. The processing device 501, ROM 502, and RAM 503 are connected to each other through a bus 504. An edit/output (Input/Output, I/O) interface 505 is also connected to the bus 504.

Generally, the following means may be connected to the I/O interface 505: an editing means 506 including, for example, a touch screen, a touchpad, a keyboard, a mouse, a camera, a microphone, an accelerometer, a gyroscope, etc.; including, for example, a liquid crystal display (LCD), an output means 507 such as a speaker, a vibrator, etc.; a storage means 508 including, for example, a magnetic tape, a hard disk, etc.; and a communication means 509. The communication means 509 may allow the electronic device 500 to perform wireless or wired communication with other devices to exchange data. Although FIG. 6 shows electronic device 500 having various means, it is not a requirement to implement or possess all of the means shown. More or fewer means may alternatively be implemented or provided.

According to an embodiment of the present disclosure, the processes described above with reference to the flowcharts may be implemented as computer software programs. For example, embodiments of the present disclosure include a computer program product, which includes a computer program carried on a non-transitory computer readable medium, where the computer program includes program code for executing the method shown in the flowchart. In such an embodiment, the computer program may be downloaded and installed from a network via communication means 509, or from storage means 508, or from ROM 502. When the computer program is executed by the processing means 501, the above-mentioned functions defined in the methods of the embodiments of the present disclosure are executed.

The names of messages or information exchanged between multiple means in the embodiments of the present disclosure are used for illustrative purposes only, and are not used to limit the scope of these messages or information.

The electronic device provided by the embodiment of the present disclosure belongs to the same concept as the method of drawing an image provided by the above embodiment, and the technical details not described in detail in this embodiment may be referred to the above embodiment, and this embodiment has the same features as the above embodiment Effect.

### Embodiment Six

An embodiment of the present disclosure provides a computer storage medium on which a computer program is stored, and when the program is executed by a processor, the method of drawing an image provided in the foregoing embodiments is implemented.

The computer-readable medium mentioned above in the present disclosure may be a computer-readable signal medium or a computer-readable storage medium, or any combination of the above two. A computer readable storage medium may be, for example, but not limited to, an electrical, magnetic, optical, electromagnetic, infrared, or semiconductor system, device, or device, or any combination thereof. Examples of computer readable storage media may include, but are not limited to: electrical connections with one or more wires, portable computer disks, hard disks, RAM, ROM, Erasable Programmable Read-Only Memory (EPROM or flash memory), optical fiber, portable compact disk read-only memory (CD-ROM), optical storage device, magnetic storage device, or any suitable combination of the above. In the present disclosure, a computer-readable storage medium may be any tangible medium that contains or stores a program that may be used by or in conjunction with an instruction execution system, apparatus, or device. In the present disclosure, however, a computer-readable signal medium may include a data signal propagated in baseband or as part of a carrier wave carrying computer-readable program code therein. Such propagated data signals may take many forms, including but not limited to electromagnetic signals, optical signals, or any suitable combination of the foregoing. A computer-readable signal medium may also be any computer-readable medium other than a computer-readable storage medium, which may transmit, propagate, or transmit a program for use by or in conjunction with an instruction execution system, apparatus, or device. The program code contained on the computer readable medium may be transmitted by any appropriate medium, including but not limited to: electric wire, optical cable, radio frequency (Radio Frequency, RF), etc., or any suitable combination of the above.

In some embodiments, the client and the server may communicate using any currently known or future network protocols such as Hypertext Transfer Protocol (HTTP), and may communicate with digital data in any form or medium The communication (e.g., communication network) interconnections. Examples of communication networks include local area networks (LAN), wide area networks (WAN), internetworks (e.g., the Internet), and peer-to-peer networks (e.g., ad hoc peer-to-peer networks), as well as any currently existing networks that are known or developed in the future.

The above-mentioned computer-readable medium may be included in the above-mentioned electronic device, or may exist independently without being incorporated into the electronic device.

The above-mentioned computer-readable medium carries one or more programs, and when the above-mentioned one or more programs are executed by the electronic device, causing the electronic device to: obtain an image to be processed; wherein the image to be processed comprises a target coating of a material to be determined; determine target light source information and target editing parameter information corresponding to the image to be processed respectively; determine target material parameter information of the target coating according to the target light source information and a target normal map of the image to be processed; determine a target image based on the target material parameter information and the target editing parameter information.

Computer program code for carrying out operations of the present disclosure may be written in one or more programming languages, or combinations thereof, including but not limited to object-oriented programming languages-such as Java, Smalltalk, C++, and Includes conventional procedural programming languages-such as the “C” language or similar programming languages. The program code may execute entirely on the user's computer, partly on the user's computer, as a stand-alone software package, partly on the user's computer and partly on a remote computer or entirely on the remote computer or server. Where a remote computer is involved, the remote computer may be connected to the user computer through any kind of network, including a LAN or WAN, or it may be connected to an external computer (e.g., via the Internet using an Internet Service Provider).

The flowchart and block diagrams in the Figures illustrate the architecture, functionality, and operation of possible implementations of systems, methods and computer program products according to various embodiments of the present disclosure. In this regard, each block in a flowchart or block diagram may represent a module, program segment, or portion of code that contains one or more logical functions for implementing specified executable instructions. It should also be noted that, in some alternative implementations, the functions noted in the block may occur out of the order noted in the figures. For example, two blocks shown in succession may, in fact, be executed substantially concurrently, or they may sometimes be executed in the reverse order, depending upon the functionality involved. It should also be noted that each block of the block diagrams and/or flowchart illustrations, and combinations of blocks in the block diagrams and/or flowchart illustrations, may be implemented by a dedicated hardware-based system that performs the specified functions or operations, or may be implemented by a combination of dedicated hardware and computer instructions.

The units involved in the embodiments described in the present disclosure may be implemented by software or by hardware. Wherein, the name of the unit does not constitute a limitation on the unit itself in one case, for example, the first obtaining unit may also be described as “a unit for obtaining at least two Internet Protocol addresses”.

The functions described herein above may be performed at least in part by one or more hardware logic components. For example, without limitation, exemplary types of hardware logic components that may be used include: Field Programmable Gate Arrays (FPGAs), Application Specific Integrated Circuits (ASICs), Application Specific Standard Products (ASSP), System on Chip (SOC), Complex Programmable Logic Device (CPLD) and so on.

In the context of the present disclosure, a machine-readable medium may be a tangible medium that may contain or store a program for use by or in conjunction with an instruction execution system, apparatus, or device. A machine-readable medium may be a machine-readable signal medium or a machine-readable storage medium. A machine-readable medium may include, but is not limited to, electronic, magnetic, optical, electromagnetic, infrared, or semiconductor systems, apparatus, or devices, or any suitable combination of the foregoing. Examples of machine-readable storage media would include one or more wire-based electrical connections, portable computer disks, hard drives, RAM, ROM, EPROM or flash memory, optical fibers, CD-ROMs, optical storage devices, magnetic storage devices, or any suitable combination of the above.

According to one or more embodiments of the present disclosure, [Example 1] provides a method of drawing an image, the method comprising:
obtaining an image to be processed; wherein the image to be processed comprises a target coating of a material to be determined;
determining target light source information and target editing parameter information corresponding to the image to be processed respectively;
determining target material parameter information of the target coating according to the target light source information and a target normal map of the image to be processed;
determining a target image based on the target material parameter information and the target editing parameter information.

According to one or more embodiments of the present disclosure, [Example 2] provides a method of drawing an image, the method further comprising:
obtaining an image to be used by photographing the target object coated with the target coating;
obtaining the image to be processed by processing the image to be used according to a preset image processing approach; wherein the target object is presented in the image to be processed at a preset ratio.

According to one or more embodiments of the present disclosure, [Example 3] provides a method of drawing an image, the method further comprising:

the image to be processed being filled with the target object, and a target object edge displayed in the image to be processed being tangent to an edge line of the image to be processed.

According to one or more embodiments of the present disclosure, [Example 4] provides a method of drawing an image, the method further comprising:
determining the target light source information corresponding to the image to be processed by processing the image to be processed based on an illumination estimation model obtained by pre-training;
obtaining the target editing parameter information corresponding to the image to be processed by processing the image to be processed based on an editor selection model obtained by pre-training.

According to one or more embodiments of the present disclosure, [Example 5] provides a method of drawing an image, the method further comprising:
obtaining pixel coordinate information of a highlight point in the image to be processed output by the illumination estimation model by inputting the image to be processed into the illumination estimation model;
determining, based on the pixel coordinate information, the target light source information of a light source upon obtaining the image to be processed by photographing;
wherein the target light source information comprises an illumination angle at which the light source illuminates the target object.

According to one or more embodiments of the present disclosure, [Example 6] provides a method of drawing an image, the method further comprising:
obtaining an attribute value output by the editor selection model corresponding to each editing parameter to be selected by inputting the image to be processed into the editor selection model;
determining the target editing parameter information from a plurality of editing parameters to be selected based on each attribute value.

According to one or more embodiments of the present disclosure, [Example 7] provides a method of drawing an image, the method further comprising:
determining the target normal map of the image to be processed;
obtaining the target material parameter information of the target coating output by a parameter generation model obtained by pre-training by processing the target normal map and the target light source information based on the parameter generation model.

According to one or more embodiments of the present disclosure, [Example 8] provides a method of drawing an image, the method further comprising:
the target material parameter information comprises reflection function parameters.

According to one or more embodiments of the present disclosure, [Example 9] provides a method of drawing an image, the method further comprising:
the reflectance function parameters comprises at least one of bidirectional reflectance distribution function, metallicity and roughness.

According to one or more embodiments of the present disclosure, [Example 10] provides a method of drawing an image, the method further comprising:
drawing the target image based on a target editor using the target material parameter information as a parameter; wherein the target editor matches the target editing parameter information.

According to one or more embodiments of the present disclosure, [Example Eleven] provides a method of drawing an image, the method further comprising:
determining the target light source information based on an illumination estimation model, determining the target editing parameter information based on an editor selection model, and determining the target material parameter information based on a parameter generation model by training the illumination estimation model, the editor selection model, and the parameter generation model.

According to one or more embodiments of the present disclosure, [Example 12] provides a method of drawing an image, the method further comprising:
obtaining a plurality of images to be trained; wherein the images to be trained is coated with a coating to be trained;
for each image to be trained, obtaining actual light source information of the image to be trained output by the illumination estimation model to be trained by inputting a current image to be trained into the illumination estimation model to be trained; and determining an editing parameter to be used from a plurality of editing parameters to be selected by inputting the current image to be trained into the editor selection model to be trained;
obtaining actual material parameter information of the coating to be trained corresponding to the current image to be trained output by the parameter generation model to be trained by using the actual light source information and the normal map of the current image to be trained as an input of the parameter generation model to be trained, and drawing an image to be compared based on the actual material parameter information;
correcting parameters in the illumination estimation model to be trained, the editor selection model to be trained and the parameter generation model to be trained based on theoretical light source information, a theoretical editing parameter, the image to be compared, the actual light source information, the editing parameter to be used corresponding to the current image to be trained and the current image to be trained;
obtaining the illumination estimation model, the editor selection model, and the parameter generation model by taking convergences of loss functions in the illumination estimation model to be trained, the editor selection model to be trained, and the parameter generation model to be trained as training targets.

According to one or more embodiments of the present disclosure, [Example 13] provides an apparatus of drawing an image, further comprising:
correcting model parameters in the illumination estimation model to be trained according to an actual distance difference by determining the actual distance difference according to the theoretical light source information and the actual light source information of the current image to be trained; or, determining a first image according to the actual light source information and the actual material parameter information of the current image to be trained, and correcting the model parameters in the illumination estimation model to be trained according to the first image and the current image to be trained;
correcting model parameters in the editor selection model to be trained according to the theoretical editing parameters and the editing parameters to be used corresponding to the current image to be trained;
correcting model parameters in the parameter generation model to be trained according to the image to be compared and the current image to be trained.

According to one or more embodiments of the present disclosure, [Example Fourteen] provides an apparatus of drawing an image, the apparatus comprising:
an image to be processed obtaining module, configured to obtain an image to be processed; wherein the image to be processed comprises a target coating of a material to be determined;
an information determining module, configured to determine target light source information and target editing parameter information corresponding to the image to be processed respectively;
an target material parameter information determining module, configured to determine target material parameter information of the target coating according to the target light source information and a target normal map of the image to be processed;
an target image determining module, configured to determine a target image based on the target material parameter information and the target editing parameter information.

Additionally, while operations are depicted in a particular order, this should not be understood as requiring that the operations be performed in the particular order shown or to be performed in a sequential order. Under certain circumstances, multitasking and parallel processing may be advantageous. Likewise, while many implementation details are contained in the above discussion, these should not be construed as limitations on the scope of the disclosure. Some features that are described in the context of separate embodiments may also be implemented in combination in a single embodiment. Conversely, various features that are described in the context of a single embodiment may also be implemented in multiple embodiments separately or in any suitable sub-combination.

What is claimed is:

1. A method of drawing an image, comprising:
obtaining an image to be processed, wherein the image to be processed comprises a target coating of a material to be determined;
determining target light source information and target editing parameter information corresponding to the image to be processed respectively;
determining target material parameter information of the target coating according to the target light source information and a target normal map of the image to be processed; and
determining a target image based on the target material parameter information and the target editing parameter information.

2. The method according to claim 1, wherein obtaining the image to be processed comprises:
obtaining an image to be used by photographing the target object coated with the target coating; and
obtaining the image to be processed by processing, according to a preset image processing approach, the image to be used; wherein the target object is presented in the image to be processed at a preset ratio.

3. The method according to claim 2, wherein the target object being presented in the image to be processed at the preset ratio comprises:
the image to be processed being filled with the target object, and a target object edge displayed in the image to be processed being tangent to an edge line of the image to be processed.

4. The method according to claim 1, wherein determining the target light source information and the target editing parameter information corresponding to the image to be processed respectively comprises:
determining the target light source information corresponding to the image to be processed by processing, based on an illumination estimation model obtained by pre-training, the image to be processed; and
obtaining the target editing parameter information corresponding to the image to be processed by processing, based on an editor selection model obtained by pre-training, the image to be processed.

5. The method according to claim 4, wherein determining the target light source information corresponding to the image to be processed by processing, based on the illumination estimation model obtained by pre-training, the image to be processed, comprises:
obtaining pixel coordinate information of a highlight point in the image to be processed output by the illumination estimation model by inputting the image to be processed into the illumination estimation model; and
determining, based on the pixel coordinate information, the target light source information of a light source upon obtaining the image to be processed by photographing,
wherein the target light source information comprises an illumination angle at which the light source illuminates the target object.

6. The method according to claim 4, wherein obtaining the target editing parameter information corresponding to the image to be processed by processing, based on an editor selection model obtained by pre-training, the image to be processed comprises:
obtaining an attribute value output by the editor selection model corresponding to each editing parameter to be selected by inputting the image to be processed into the editor selection model; and
determining the target editing parameter information from a plurality of editing parameters to be selected based on each attribute value.

7. The method according to claim 1, wherein determining the target material parameter information of the target coating according to the target light source information and the target normal map of the image to be processed comprises:
determining the target normal map of the image to be processed; and
obtaining the target material parameter information of the target coating output by a parameter generation model obtained by pre-training by processing, based on the parameter generation model, the target normal map and the target light source information.

8. The method according to claim 7, wherein the target material parameter information comprises reflection function parameters.

9. The method according to claim 8, wherein the reflectance function parameters comprise at least one of bidirectional reflectance distribution function, metallicity and roughness.

10. The method according to claim 1, wherein determining the target image based on the target material parameter information and the target editing parameter information comprises:
drawing the target image based on a target editor using the target material parameter information as a parameter; wherein the target editor matches the target editing parameter information.

11. The method according to claim 1, wherein before determining the target light source information, target editing parameter information and the target material parameter information, the method further comprises:
determining the target light source information based on an illumination estimation model, determining the target editing parameter information based on an editor selection model, and determining the target material parameter information based on a parameter generation model by training the illumination estimation model, the editor selection model, and the parameter generation model.

12. The method according to claim 11, wherein training the illumination estimation model, the editor selection model, and the parameter generation model comprises:
obtaining a plurality of images to be trained; wherein the images to be trained are coated with a coating to be trained;
for each image to be trained, obtaining actual light source information of the image to be trained output by the illumination estimation model to be trained by inputting a current image to be trained into the illumination estimation model to be trained; and determining an editing parameter to be used from a plurality of editing parameters to be selected by inputting the current image to be trained into the editor selection model to be trained;
obtaining actual material parameter information of the coating to be trained corresponding to the current image to be trained output by the parameter generation model to be trained by using the actual light source information and the normal map of the current image to be trained as an input of the parameter generation model to be trained, and drawing an image to be compared based on the actual material parameter information;
correcting parameters in the illumination estimation model to be trained, the editor selection model to be trained and the parameter generation model to be trained based on theoretical light source information, a theoretical editing parameter, the image to be compared, the actual light source information, the editing parameter to be used corresponding to the current image to be trained and the current image to be trained; and
obtaining the illumination estimation model, the editor selection model, and the parameter generation model by taking convergences of loss functions in the illumination estimation model to be trained, the editor selection model to be trained, and the parameter generation model to be trained as training targets.

13. The method according to claim 12, wherein correcting parameters in the illumination estimation model to be trained, the editor selection model to be trained and the parameter generation model to be trained based on theoretical light source information, a theoretical editing parameter, the image to be compared, the actual light source information, the editing parameter to be used corresponding to the current image to be trained and the current image to be trained comprises:
correcting model parameters in the illumination estimation model to be trained according to an actual distance difference by determining the actual distance difference according to the theoretical light source information and the actual light source information of the current image to be trained; or, determining a first image according to the actual light source information and the actual material parameter information of the current image to be trained, and correcting the model parameters in the illumination estimation model to be trained according to the first image and the current image to be trained;
correcting model parameters in the editor selection model to be trained according to the theoretical editing parameters and the editing parameters to be used corresponding to the current image to be trained; and
correcting model parameters in the parameter generation model to be trained according to the image to be compared and the current image to be trained.

14. (canceled)

15. An electronic device, comprising:
at least one processor; and
a store configured to store at least one program;
the at least one program, when executed by the at least one processor, causes the at least one processor to:
obtain an image to be processed, wherein the image to be processed comprises a target coating of a material to be determined;
determine target light source information and target editing parameter information corresponding to the image to be processed respectively;
determine target material parameter information of the target coating according to the target light source information and a target normal map of the image to be processed; and
determine a target image based on the target material parameter information and the target editing parameter information.

16. A non-transitory storage medium containing computer-executable instructions, the computer-executable instructions, when executed by a computer processor, cause the computer processor to:
obtain an image to be processed, wherein the image to be processed comprises a target coating of a material to be determined;
determine target light source information and target editing parameter information corresponding to the image to be processed respectively;
determine target material parameter information of the target coating according to the target light source information and a target normal map of the image to be processed; and
determine a target image based on the target material parameter information and the target editing parameter information.

17. The electronic device according to claim 15, wherein the at least one program causes the at least one processor to obtain the image to be processed by:
obtaining an image to be used by photographing the target object coated with the target coating; and
obtaining the image to be processed by processing, according to a preset image processing approach, the image to be used; wherein the target object is presented in the image to be processed at a preset ratio.

18. The electronic device according to claim 17, wherein the image to be processed is filled with the target object, and a target object edge displayed in the image to be processed is tangent to an edge line of the image to be processed.

19. The electronic device according to claim 15, wherein the at least one program causes the at least one processor to determine the target light source information and the target editing parameter information corresponding to the image to be processed respectively by:
determining the target light source information corresponding to the image to be processed by processing, based on an illumination estimation model obtained by pre-training, the image to be processed; and
obtaining the target editing parameter information corresponding to the image to be processed by processing, based on an editor selection model obtained by pre-training, the image to be processed.

20. The electronic device according to claim 19, wherein the at least one program causes the at least one processor to determine the target light source information corresponding to the image to be processed by processing, based on the illumination estimation model obtained by pre-training, the image to be processed, by:
obtaining pixel coordinate information of a highlight point in the image to be processed output by the illumination estimation model by inputting the image to be processed into the illumination estimation model; and
determining, based on the pixel coordinate information, the target light source information of a light source upon obtaining the image to be processed by photographing, wherein the target light source information comprises an illumination angle at which the light source illuminates the target object.

21. The electronic device according to claim 19, wherein the at least one program causes the at least one processor to obtain the target editing parameter information corresponding to the image to be processed by processing, based on an editor selection model obtained by pre-training, the image to be processed by:
obtaining an attribute value output by the editor selection model corresponding to each editing parameter to be selected by inputting the image to be processed into the editor selection model; and
determining the target editing parameter information from a plurality of editing parameters to be selected based on each attribute value.
